(19) United States
(12) Patent Application Publication
(10) Pub. No.: US 2018/0051666 A1
(43) Pub. Date: Feb. 22, 2018

(54) ROTARY NEEDLE FUEL INJECTOR

(71) Applicant: Robert Bosch GmbH, Stuttgart (DE)

(72) Inventors: Joel Oudart, Mountain View, CA (US); Eric Doran, El Segundo, CA (US)

(21) Appl. No.: 15/240,045

(22) Filed: Aug. 18, 2016

(51) Int. Cl. F02M 61/10

(52) U.S. Cl. CPC F02M 61/10; F02M 2200/29

(57) ABSTRACT

A rotary needle fuel injector having a housing including a wall having a plurality of non-circular apertures extending through the wall and a rotatable rod inside the housing and having a bore through which fuel is supplied. The rotatable rod has a plurality of apertures communicating with the bore and in selective communication with the non-circular apertures in the housing wall. The non-circular apertures also include an axis of symmetry extending along a direction of rotation of the rotatable rod and an axis of asymmetry perpendicular to the axis of symmetry.

### FIELD

The invention generally relates to fuel injectors, and more particularly to a rotary needle fuel injector.

### BACKGROUND

In some internal combustion engines, a specific fuel injection rate is desired to help achieve the operating targets. For example, modern diesel engines often use injection strategies in order to meet combustion emissions and noise constraints. In a conventional fuel injector, a desired fuel injection rate shape over time is approximated by executing multiple injection pulses at specified times and durations. It can be difficult to achieve a desired injection profile with this approach due to limitations in timing the activation of an injector needle relative to the timing of a combustion process.

Conventional fuel injectors for diesel engines include an internal needle which moves linearly within an injector housing. When the needle is positioned against a seat, which acts as a sealing surface on the housing, the fuel that is supplied to the housing is blocked. As the needle moves away from the seat, a pathway past the needle and through one or more nozzle holes is created to a downstream combustion chamber. A pressure difference between the high pressure fuel supply and the combustion chamber drives the fuel through the nozzle holes into the combustion chamber.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure are related to systems and methods for a rotary needle fuel injector that achieves a desired injection profile.

One embodiment includes a rotary needle fuel injector having a housing including a wall having a non-circular aperture extending through the wall, and a rotatable rod inside the housing and having a bore through which fuel is supplied. The rotatable rod has an aperture communicating with the bore and in selective communication with the non-circular aperture in the housing wall.

Another embodiment includes a rotary needle fuel injector having a housing including a wall having a plurality of non-circular apertures extending through the wall, and a rotatable rod inside the housing and having a bore through which fuel is supplied. The rotatable rod has a plurality of apertures communicating with the bore and in selective communication with the non-circular apertures in the housing wall. The non-circular apertures each include an axis of symmetry extending along a direction of rotation of the rotatable rod, an axis of asymmetry perpendicular to the axis of symmetry, and a ratio of a cross-sectional area of a first region of the non-circular aperture to a cross-sectional area of a second region of the non-circular aperture ranges from about 1:10 to about 1:1.5.

The details of one or more features, aspects, implementations, and advantages of this disclosure are set forth in the accompanying drawings, the detailed description, and the claims below.

### BRIEF DESCRIPTION OF THE DRAWINGS

FIG. 1 is a perspective view of a rotary needle fuel injector in accordance with an embodiment of the invention.

FIG. 2 is an exploded view of the rotary needle fuel injector of FIG. 1.

FIG. 3 is an enlarged schematic view of the non-circular aperture of FIG. 1.

FIG. 4A is a schematic view of non-overlapping positions of the apertures.

FIG. 4B is a schematic view of partially overlapping apertures.

FIG. 4C is a schematic view of fully overlapping apertures.

FIG. 5 is an illustration of fuel flow versus time for a rotary needle fuel injector embodying the present invention and a conventional fuel injector.

### DETAILED DESCRIPTION

One or more specific embodiments will be described below. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

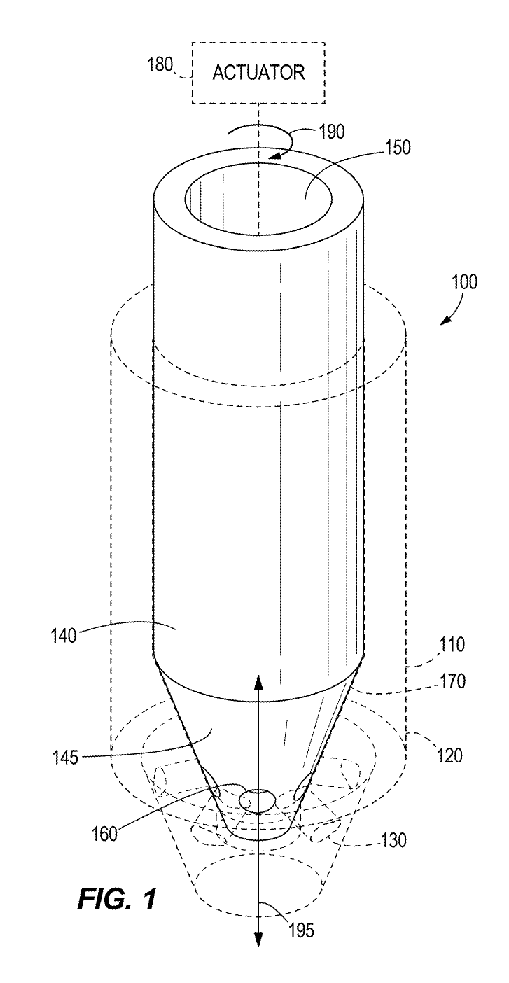

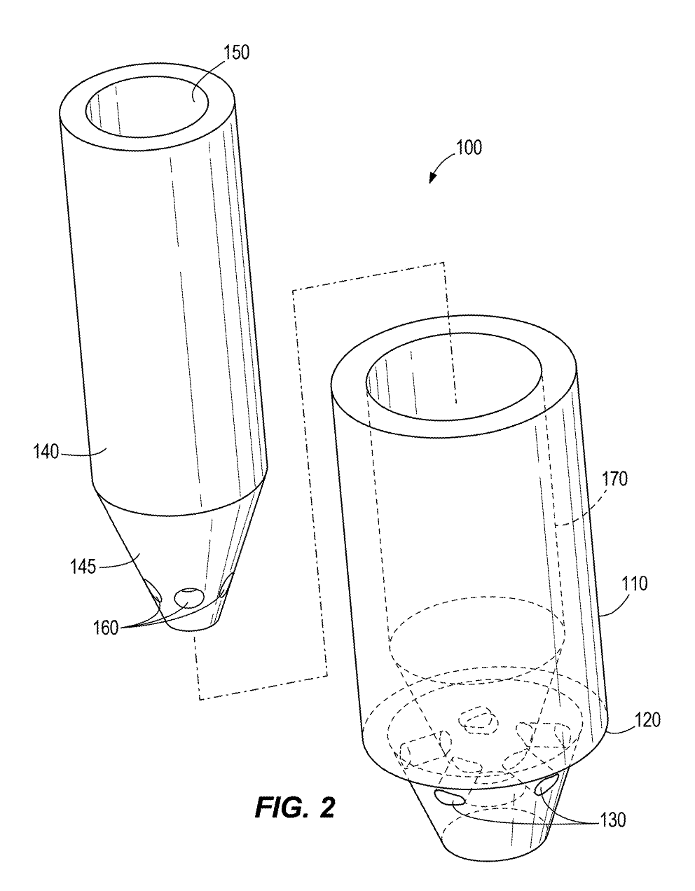

An embodiment of a rotary needle fuel injector 100 is shown in FIGS. 1 and 2. The rotary needle fuel injector 100 includes a housing 110 having a housing wall 120 including at least one non-circular aperture 130 extending through the housing wall 120. The housing wall 120 further defines a cavity 170. The rotary needle fuel injector 100 additionally includes a rotatable rod 140 positioned for rotation inside the cavity 170. The rod 140 has a bore 150 through which fuel is supplied. The rotatable rod 140 further includes at least one aperture 160 extending through a wall 145 of the rotatable rod 140 and in communication with the bore 150 such that fuel can flow from the bore 150 to the at least one aperture 160. The at least one aperture 160 in the rod 140 is in selective communication with the at least one non-circular aperture 130 in the housing wall 120 such that when aligned, fuel can flow from the at least one aperture 160 in the rod 140 into and through the at least one non-circular aperture 130 in the housing 110 for injection into a combustion chamber. The rotatable rod 140 may be rotated by an actuator 180 (e.g., a hydraulic, electrical (e.g., piezoelectric), or electromagnetic (e.g., stepper motor) actuator). The actuator 180 may control the rotation of the rotatable rod 140 to within 7 of seconds of arc.

The operation of the rotary needle fuel injector 100 results in selective communication of apertures 130, 160 to provide the desired injection to the combustion chamber. FIGS. 1 and 2 illustrate a single row of apertures 160 in the rotatable rod 140 and a single row of apertures 130 in the housing 110, each row is shown as having five apertures. In other embodiments, the number of rows, the number of holes in each row and the shape of the apertures 160 may change (e.g., single row, plurality of rows, and/or grid). The at least one aperture 160 in the rotatable rod 140 is illustrated as being circular in shape and extends through the wall 145 of the rotatable rod 140. In other embodiments the at least one aperture 160 in the rotatable rod 140 may be non-circular in shape. During the rotation of the rotatable rod 140, the aperture 160 enters into selective communication with the non-circular aperture 130. The selective communication repeats as the rod 140 rotates within the cavity 170, such that each aperture 160 in the row of apertures 160 in the rotatable rod 140 will selectively communicate with each non-circular aperture 130 in the row of apertures 130 in the housing 110, as the rod 140 rotates through three hundred sixty degrees of rotation.

As illustrated, the size of the non-circular aperture 130 in the housing 110 generally increases in the direction of rotation 190 of the rotatable rod 140. To state it yet another way, the non-circular aperture 130 in the housing generally increases from a smaller size to a larger size in the direction of rotation 190 of the rotatable rod 140. As illustrated, the non-circular aperture is tear-drop shaped. Additionally, the cross-sectional shape of the non-circular aperture 130 extending through the housing wall 120 remains substantially constant through the thickness of the housing wall 120. In other embodiments, the cross-sectional shape of the non-circular aperture 130 may increase in size, and/or decrease in size through the thickness of the housing wall 120. Furthermore, the shape of each of the non-circular apertures 130 may be the same or different. Additionally, in other embodiments the shape of the at least one aperture 160 in the rotatable rod 140 may be non-circular in shape.

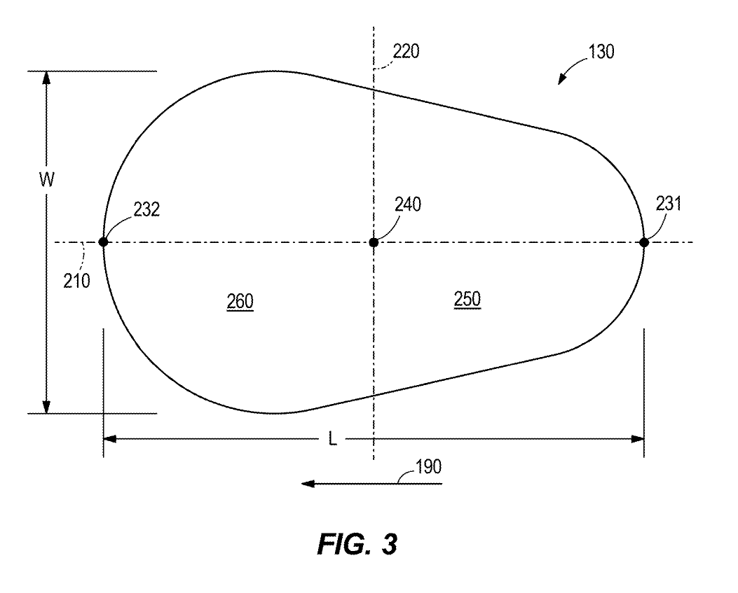

FIG. 3 schematically illustrates the non-circular aperture 130 through the housing wall 120. The non-circular aperture 130 has a length L in the direction of rotation 190, between a leading distal end 231 and a trailing distal end 232. The leading distal end 231 overlaps first with the aperture 160 of the rotatable rod 140, and the trailing distal end 232 is the last point of overlap with the aperture 160 of the rotatable rod 140. The distal ends 231, 232 are spaced apart in the direction of rotation by length L. In the illustrated embodiment, L can be 40 to 300 microns depending on the particular injector application. In other embodiments, the length of the aperture 160 in the direction of rotation 180 may be shorter than 40 microns or longer than 300 microns. Furthermore, the leading and trailing distal ends 231, 232 lie on an axis 210 that is parallel to the direction of rotation 190. The non-circular aperture 130 is symmetrical about the axis 210, and therefore, the axis 210 is an axis of symmetry. Furthermore, the axis of symmetry 210 is substantially perpendicular to a direction of fuel flow from the bore 150 through the apertures 160 and 130.

The non-circular aperture 130 further defines a mid-point 240 which is defined as halfway between the leading distal end 231 and the trailing distal end 232. A perpendicular axis 220 runs through the mid-point 240 perpendicular to the axis 210. The perpendicular axis 220 defines an axis of asymmetry of the aperture 130. The axis of asymmetry 220 is substantially perpendicular to the direction of fuel flow from the bore 150 through the apertures 160 and 130. The non-circular aperture 130 further defines a width W in a direction perpendicular to the direction of rotation 190. The width W corresponds to the widest portion of the non-circular aperture 130 in a direction perpendicular to the direction of rotation 190. The width W may lie along the axis of asymmetry 220 of the non-circular aperture or may be located elsewhere within the non-circular aperture 130. In the illustrated embodiment, the width W can be 70 microns to 200 microns. In other embodiments, the widest section or width W of the non-circular aperture 130 in the direction perpendicular to the direction of rotation 190 may be outside of the previous range. The region of the aperture 130 between the leading distal end 231 and the perpendicular axis 220 is defined as a first region 250. The region between the trailing distal end 232 and the perpendicular axis 220 is defined as a second region 260. A ratio of the area of the first region 250 to the area of the second region 260 may be 1:50 to 1:1.3. In other embodiments, the ratio of the area of the first region 250 to the area of the second region 260 may be 1:10 to 1:1.5.

The specific shape of the non-circular aperture 130 may be chosen to determine the rate at which a cross-section of the non-circular aperture 130 in selective communication with the aperture 160 changes for each unit of arc of rotation of the rotatable rod 140. This allows for the fine tuning of the fuel injection rate profile. As an alternative to the illustrated tear-drop shape, the non-circular aperture 130 may include one or more other non-circular shapes (e.g., oval, ovoid, ellipse, triangle, parallelogram, rhombus, rectangle, square, diamond, and combinations thereof). The specific shape can be customized to achieve the desired injection rate profile.

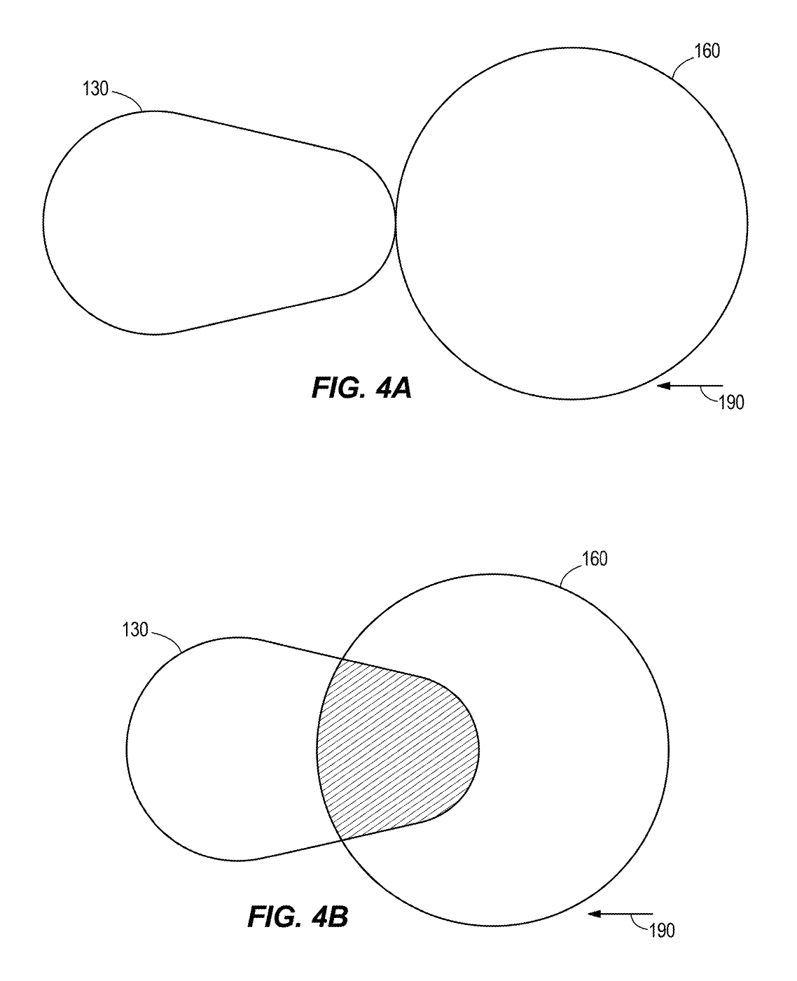

During the operation of the rotary needle fuel injector 100, the apertures 130, 160 are in varying degrees of overlap. FIGS. 4A, 4B and 4C illustrate the overlap of the apertures 130 and 160 during the rotation of the rotatable rod 140. FIG. 4A illustrates no overlap between the non-circular aperture 130 and the aperture 160 resulting in no fuel flow through the rotatory needle fuel injector 100 (or at least through the illustrated apertures 130, 160). As the rotatable rod 140 rotates such that the apertures 130 and 160 partially overlap, as shown in FIG. 4B, fuel flows through the rotary needle fuel injector 100. To allow the maximum fuel flow through the rotary needle fuel injector 100, the rotatable rod 140 is positioned to allow the complete overlap of the non-circular aperture 130 and the aperture 160 as shown in FIG. 4C. Furthermore, in order to allow the maximum fuel flow through the rotary needle fuel injector 100 the diameter of the circular aperture 160 in the rod 140 is greater than or equal to the larger of the length dimension L of the non-circular aperture 130 in the direction of rotation 190 or the width dimension W of the non-circular aperture 130 in a direction perpendicular to the direction of rotation 190.

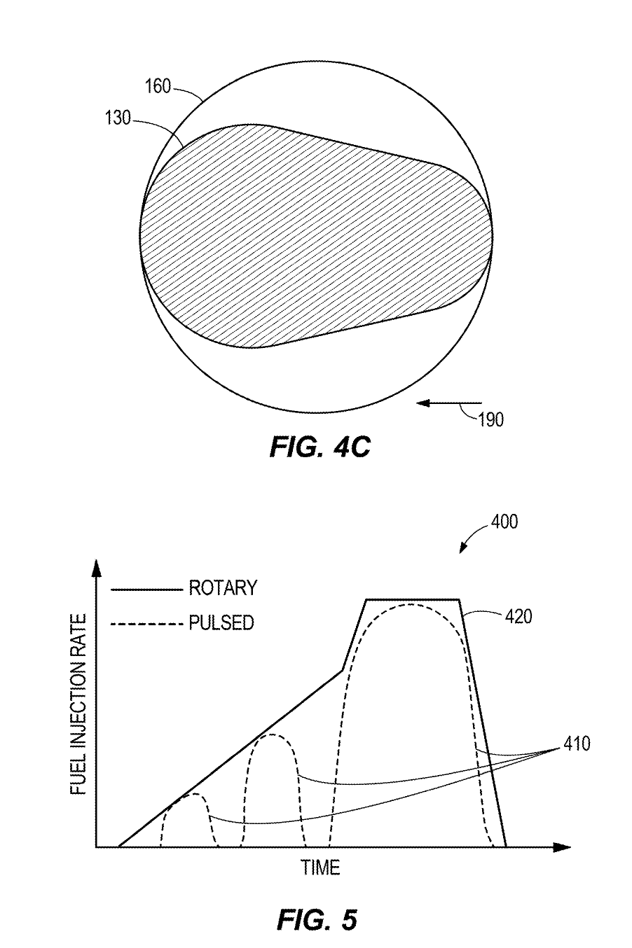

FIG. 5 illustrates a fuel injection rate profile 400 of an embodiment of a rotary needle fuel injector 100 versus a conventional pulsed injection profile. A conventional needle type fuel injector relies on a series of pulsed injections of fuel in order to provide the actual fuel injection rate 410 to the engine. The series of pulses is limited by the rate in which the needle of the needle type fuel injector can be actuated. The combination of the shape of the non-circular aperture 130, the size and shape of the aperture 160 in the rod 140, and the rotation of the rotatable rod 140 can be coordinated to provide the desired, uninterrupted fuel injection profile to the engine 420. Uninterrupted fuel injection may result in more precisely controlled engine output and/or an increase in the rate of engine responsiveness to a driver's input, as compared to conventional fuel injectors.

The apertures 130, 160 of the rotary needle fuel injector 100 may be formed using various computer-controlled manufacturing techniques (e.g., laser drilling). Techniques such as computer-controlled laser drilling allow for the aperture shapes/profiles to be customized based on the performance requirements of the engine. Control of the aperture shapes/profiles through the thickness of the housing wall 110 and the rod wall 145 allows the volume and/or turbulence of the fuel flow through the injector 100 to be customized.

It is believed that embodiments described herein and many of their attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A rotary needle fuel injector comprising:
a housing including a wall having a non-circular aperture extending through the wall; and
a rotatable rod inside the housing and having a bore through which fuel is supplied, the rotatable rod having an aperture communicating with the bore and in selective communication with the non-circular aperture in the housing wall.

2. The rotary needle fuel injector of claim 1, wherein the non-circular aperture includes an axis of symmetry.

3. The rotary needle fuel injector of claim 2, wherein the axis of symmetry extends along a direction of rotation of the rotatable rod.

4. The rotary needle fuel injector of claim 3, wherein a length L of the non-circular aperture, as measured in the direction of rotation, ranges from 70 microns to 200 microns.

5. The rotary needle fuel injector of claim 3, wherein a width W of the non-circular aperture, as measured perpendicular to the direction of rotation, ranges from 30 microns to 140 microns.

6. The rotary needle fuel injector of claim 2, wherein the non-circular aperture further includes an axis of asymmetry perpendicular to the axis of symmetry.

7. The rotary needle fuel injector of claim 6, wherein a cross-sectional area of a first region of the non-circular aperture on one side of the axis of asymmetry is less than a cross-sectional area of a second region of the non-circular aperture on another side of the axis of asymmetry.

8. The rotary needle fuel injector of claim 7, wherein the ratio of the cross-sectional area of the first region to the cross-sectional area of the second region ranges from 1:50 to 1:1.3.

9. The rotary needle fuel injector of claim 8 wherein, the ratio of the cross-sectional area of the first region to the cross-sectional area of the second region ranges from 1:10 to 1:1.5.

10. The rotary needle fuel injector of claim 6 wherein, the axis of symmetry is substantially perpendicular to a direction of fuel flow from the bore through the apertures, and the axis of asymmetry is also substantially perpendicular to the direction of fuel flow from the bore through the apertures.

11. The rotary needle fuel injector of claim 1, wherein the non-circular aperture increases in size in a direction of rotation of the rotatable rod.

12. The rotary needle fuel injector of claim 1, wherein the wall of the housing includes a plurality of non-circular apertures, and the rotatable rod includes a plurality of apertures.

13. The rotary needle fuel injector of claim 12, wherein each of the plurality of non-circular apertures in the wall are the same.

14. The rotary needle fuel injector of claim 1, wherein the aperture in the rotatable rod is circular.

15. The rotary needle fuel injector of claim 14, wherein a diameter of the circular aperture is greater than or equal to the larger of a length dimension L of the non-circular aperture in the direction of rotation of the rotatable rod or a width dimension W of the non-circular aperture in a direction perpendicular to the direction of rotation.

16. The rotary needle fuel injector of claim 1, wherein the non-circular aperture has a generally tear-drop shape oriented with a longitudinal axis parallel to a direction of rotation of the rotatable rod.

17. The rotary needle fuel injector of claim 1, wherein the rotatable rod is rotated by a hydraulic actuator or an electrical actuator.

18. The rotary needle fuel injector of claim 17, wherein the rotation of the rotatable rod is controllable to within 7 seconds of arc.

19. A rotary needle fuel injector comprising:
a housing including a wall having a plurality of non-circular apertures extending through the wall; and
a rotatable rod inside the housing and having a bore through which fuel is supplied, the rotatable rod having a plurality of apertures communicating with the bore and in selective communication with the non-circular apertures in the housing wall;
wherein the non-circular apertures each include an axis of symmetry extending along a direction of rotation of the rotatable rod, an axis of asymmetry perpendicular to the axis of symmetry, and a ratio of a cross-sectional area of a first region of the non-circular aperture on one side of the axis of asymmetry to a cross-sectional area of a second region of the non-circular aperture on another side of the axis of asymmetry ranges from about 1:10 to about 1:1.5.

20. The rotary needle fuel injector of claim 19, wherein each of the non-circular apertures increases in size in a direction of rotation of the rotatable rod.
